(19) United States
(12) Patent Application Publication
(10) Pub. No.: US 2012/0282409 A1
(43) Pub. Date: Nov. 8, 2012

(54) RECYCLED NYLON MATERIALS FOR USE IN REFRIGERATION SYSTEMS

(75) Inventor: Matthew J. Heidecker, Troy, OH (US)

(73) Assignee: EMERSON CLIMATE TECHNOLOGIES, INC., Sidney, OH (US)

(21) Appl. No.: 13/461,555

(22) Filed: May 1, 2012

Related U.S. Application Data
(60) Provisional application No. 61/482,095, filed on May 3, 2011.

(51) Int. Cl. B23P 15/00; B05D 7/00

(52) U.S. Cl. 427/401; 29/888.02

(57) ABSTRACT

Methods of forming an integral component for a compressor and methods for improving ductility of an integral component for a compressor are provided. The integral component is formed of a recycled nylon and a recycled polypropylene. Recycled carpet is used to provide the recycled nylon and recycled polypropylene. The integral components are useful for heating, ventilation, and air conditioning (HVAC) systems and refrigeration devices.

### CROSS-REFERENCE TO RELATED APPLICATIONS

This application claims the benefit of U.S. Provisional Application No. 61/482,095, filed on May 3, 2011. The entire disclosure of the above application is incorporated herein by reference.

### FIELD

The present disclosure relates to recycled nylon material compositions to form integral components for refrigeration and heating, ventilation, and air conditioning applications.

### BACKGROUND

The statements in this section merely provide background information related to the present disclosure and may not constitute prior art.

The formation and selection of various components for refrigeration systems require consideration of the refrigeration conditions including temperature, pressure, varying performance demands, and the processing of lubricants and refrigerants in the system. An exemplary component of a refrigeration system is a compressor. In the working environment of the compressor, the respective components of the compressor need to have physical integrity for the high-pressure conditions and also chemical compatibility with lubricants and/or refrigerants used. As the refrigeration demands change, there are variations in the internal stresses, temperatures, and other working conditions of the compressor. Similarly, as demands in the refrigeration system change, there are also changes in the working conditions of the refrigeration system. Accordingly, integral integrity, ductility, performance, and longevity of materials for use in the refrigeration system can be important considerations.

### SUMMARY

Further areas of applicability will become apparent from the description provided herein. It should be understood that the description and specific examples are intended for purposes of illustration only and are not intended to limit the scope of the present disclosure.

In summary, in various aspects the present teachings provide methods of forming an integral component for a compressor. A recycled composition including a scrap nylon and a scrap polypropylene is shaped to form a solid integral component for the compressor.

In still other features of the present teachings, methods of improving ductility of an integral component of a compressor are provided. The integral component of the compressor is formed with a recycled composition obtained from scrap carpet including nylon fibers and a polypropylene backing. The integral component is contacted and optionally infiltrated with at least one of a refrigerant and a lubricant.

The present teachings also provide methods of forming a compressor. An integral component is disposed on an internal surface of the compressor, where the integral component is formed of a recycled composite material scrap nylon and scrap polypropylene. A housing is hermetically sealed forming part of the compressor about the integral component.

In still other aspects, the present teachings provide an integral component for a scroll compressor formed from a recycled composition including a scrap nylon and a scrap polyethylene.

### DRAWINGS

The drawings described herein are for illustration purposes only and are not intended to limit the scope of the present disclosure in any way.

FIG. 1 is a cross-sectional view of a scroll machine according to various embodiments of the present teachings;

FIG. 2 is an enlarged view of a suction baffle according to certain embodiments of the present teachings;

FIG. 3 is an enlarged view of a counterweight cup according to certain embodiments of the present teachings;

FIG. 4 is an enlarged view of a suction muffler according to certain embodiments of the present teachings;

FIG. 5 is a chart comparing the strain at break percentage for a Control and a Recycled Example according to certain variations of the present teachings;

FIG. 6 is a chart comparing the tensile modulus for a Control and a Recycled Example according to certain variations of the present teachings; and

FIG. 7 is a chart comparing the tensile strength for a Control and a Recycled Example according to certain variations of the present teachings.

### DETAILED DESCRIPTION

The following description is merely exemplary in nature and is not intended to limit the present disclosure, application, or uses. It should be understood that throughout the drawings, corresponding reference numerals indicate like or corresponding parts and features.

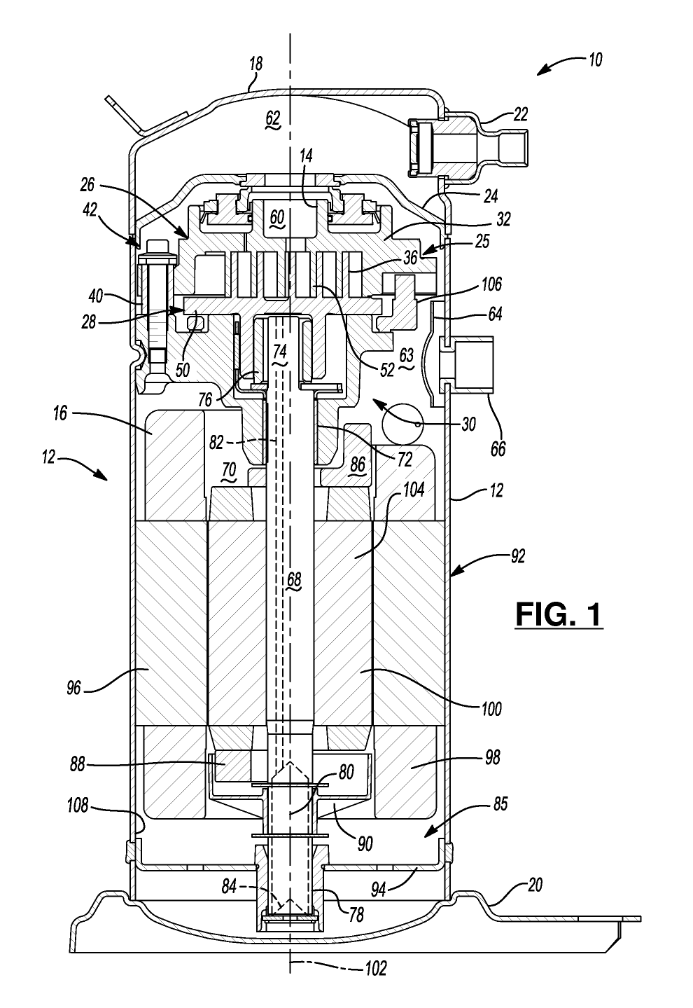

The present teachings relate to integral components for use in refrigeration or other heat transfer systems. The present teachings are particularly useful for integral components for a compressor in a refrigeration system, such as an exemplary scroll compressor 10 as depicted in FIG. 1. While the scroll compressor 10 is used as the primary example in the present disclosure, it is understood that these teachings are applicable to other types of compressors (e.g., reciprocating compressors). Further, the principles of the present disclosure also pertain to other mechanical or electromechanical devices, including engines, pumps, and devices related to heating, ventilation, and air conditioning (HVAC) systems and refrigeration systems. For clarity, a description of the scroll compressor 10 is provided first, followed by details on the materials forming the components of the scroll compressor 10.

### Scroll Machines

With reference to FIG. 1, the scroll machine 10 includes a hermetic shell 12, a compressor section 14, and a motor-drive section 16. The hermetic shell 12 facilitates “hermetically sealing” the device so that it is impervious to gases. The hermetic shell 12 is generally cylindrical in shape as shown. The hermetic shell 12 includes a cap 18 welded at the upper end thereof and a base 20 welded at the lower end thereof. The cap 18 includes a refrigerant-discharge fitting 22, which may have a discharge valve therein (not shown). The hermetic shell 12 also includes a suction inlet fitting 66 to create a suction chamber 63. The base 20 includes a plurality of mounting feet (not shown) integrally formed therewith. The hermetic shell 12 may further include a transversely extending partition 24 that is welded about its periphery at the same point that the cap 18 is welded to the hermetic shell 12.

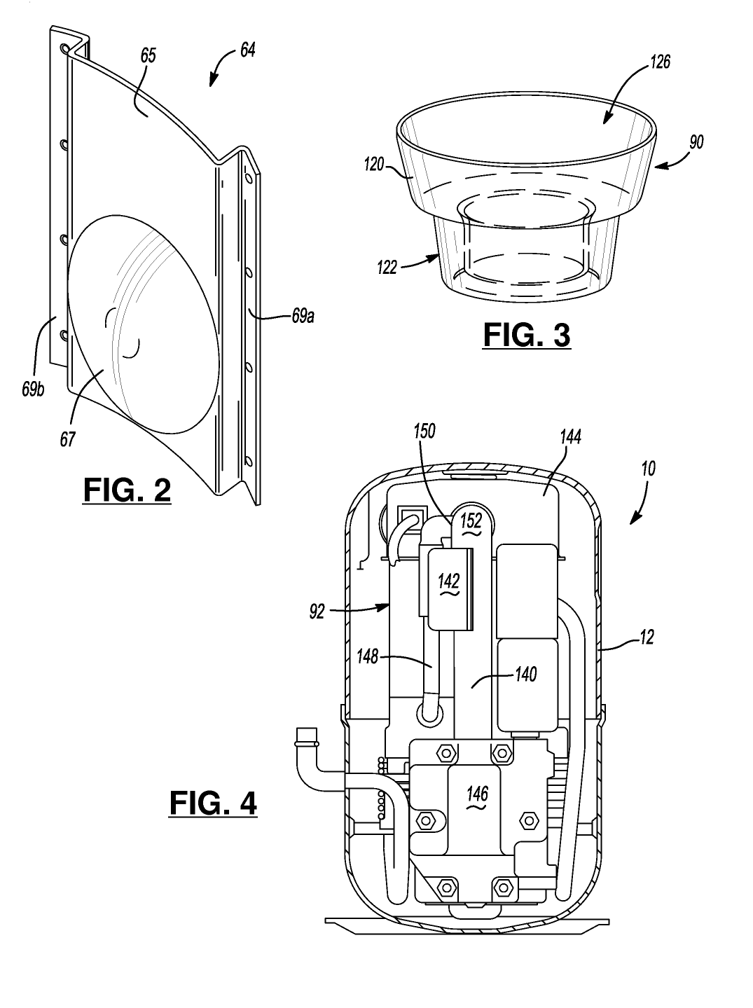

Optionally, a suction baffle 64 is secured to shell 12 in overlying relationship to suction inlet 66. As best seen with reference to FIG. 2, suction baffle 64 includes an arcuately shaped axially elongated mid or central portion 65 having a dome shaped depression 67 formed therein adjacent one end thereof. The suction baffle 64 is positioned in relationship to the hermetic shell 12 using a pair of standoff flange portions 69a and 69b extending along the opposite lateral edges of mid-portion 65.

The dome shaped depression 67 may be centered vertically and circumferentially on inlet port 66 with the concave side facing the inlet port 66. The relationship of the inlet port 66 and the dome 67 helps to prevent an upstream refrigeration system from being subjected to excessive back pressures, serves to minimize the reflection of compressor noise or vibration outwardly through the inlet port 66, and prevents suction gas and liquid refrigerant from directly impinging on bearing housing 30. An exemplary suction baffle is detailed in commonly assigned U.S. Pat. No. 5,055,010, which is incorporated herein by reference.

Returning to FIG. 1, the compressor section 14 includes a compression mechanism 25, a non-orbiting scroll member 26, a seal assembly 27, an orbiting scroll member 28, and a bearing housing 30. The non-orbiting scroll member 26 includes an end plate 32 having a spiral wrap or involute 36 extending therefrom. The non-orbiting scroll member 26 is secured to the bearing housing 30 and may include a plurality of sleeve guides 40 that attach the non-orbiting scroll member 26 to the bearing housing 30 by a plurality of bolts 42. The seal assembly 27 includes a lower seal plate 29 and may be adjacent the non-orbiting scroll end plate 32.

The orbiting scroll member 28 includes an end plate 50 and a spiral wrap 52 that extends upright from the end plate 50. The spiral wrap or involute 52 is meshed with the spiral wrap 36 of the non-orbiting scroll member 26 to form compression chambers 54 that may fluidly communicate with a discharge port 60. The discharge port 60 communicates with a discharge chamber 62 that is optionally formed by the extending partition 24 and the cap 18.

The motor-drive section 16 includes a drive member such as a crankshaft 68 coupled to the orbiting scroll member 28 to drive the compression mechanism. The crankshaft 68 is rotatably journaled in a bearing 72 in the bearing housing 30 and includes an eccentric shaft portion 74. The eccentric shaft portion 74 is coupled to the orbiting scroll member 28 through a drive bushing and bearing assembly 76. The crankshaft 68 is supported by the motor-drive section 16 at a lower end thereof, whereby the lower end of the crankshaft 68 includes a concentric shaft portion 78.

The lower end of the crankshaft 68 includes a concentric bore 80 that communicates with a radially inclined bore 82 extending upwardly therefrom to the top of the crankshaft 68. A lubricant flinger 84 is disposed within the bore to pump fluid disposed in a sump 85 or lower end of the hermetic shell (e.g., within the base 20) through the bores 80, 82 to the compressor section 14 and other portions of the scroll machine 10 requiring lubrication. The lubricant flinger 84 is of the type disclosed in commonly owned U.S. Pat. No. 7,179,069, the disclosure of which is incorporated herein by reference.

Upper and lower counterweights 86, 88 are attached to the crankshaft 68 via a rotor 100. Additionally, a counterweight shield 90 is also provided to reduce the work loss caused by the lower counterweight 88 coming in contact with lubricant disposed within the hermetic shell 12. The counterweight shield 90 may be of the type disclosed in commonly owned U.S. Pat. Nos. 5,064,356 and 7,413,423, the disclosures of which are incorporated herein by reference. As best shown in FIG. 3, the shield 90 includes an upper portion 120 that is generally formed in the shape of a cup with a generally circular periphery and a lower portion 122 that is generally in the shape of a cup with a generally triangular periphery.

Returning to FIG. 1, the motor-drive section 16 includes a motor assembly 92 and a lower bearing support member 94. The motor assembly 92 is securely mounted in the hermetic shell 12 and may include a stator 96, windings 98, and the rotor 100. The stator 96 is press fit in the hermetic shell 12, while the rotor 100 is press fit on the crankshaft 68. The stator 96, windings 98, and rotor 100 work together to drive the crankshaft 68 and thereby cause the orbiting scroll member 28 to orbit relative to the non-orbiting scroll member 26 when the motor assembly 92 is energized.

It is understood that the support member 94 may be part of a bearing assembly that includes a variety of subcomponents (not shown) such as a lower bearing and a thrust washer, as non-limiting examples, as detailed in commonly owned U.S. Pat. No. 4,850,819, which is incorporated herein by reference. The support member 94 is attached to the hermetic shell 12 and rotatably supports the crankshaft 68 which rotates about the vertical axis 102 defined by the support member 94 and the lower bearing.

The support member 94 is attached to the hermetic shell 12 in any suitable manner. For example, the support member 94 can be staked to the shell in a manner similar to that described in commonly owned U.S. Pat. No. 5,267,844, the disclosure of which is incorporated herein by reference. Alternatively or additionally, the support member 94 is attached to the hermetic shell 12 using a plurality of fasteners (not shown).

Additionally, as best illustrated in the partial cut-away of FIG. 4, the scroll compressor 10 may also include other integral features, such as a suction conduit assembly 140 including a suction muffler 142 to reduce the noise of operation. As shown, the suction muffler 140 is attached in a first opening (not shown) near a motor cover 144 and extends downwardly and is fitted in a head 146 where suction gas is supplied. The assembly further includes a bypass conduit 148 that extends from the opening near the motor cover 144 to an opening 150 provided in the sidewall of an upper conduit portion 152 of the suction conduit assembly 140. Exemplary suction mufflers are disclosed in commonly assigned U.S. Pat. No. 5,341,654, which is incorporated herein by reference.

### Materials and Methods

In one aspect, the present teachings provide methods of forming an integral component for a compressor 10 using a material composition that is recycled and includes a scrap nylon material and scrap polypropylene material. As used herein, an “integral component” includes an integral or working part of a device that facilitates its operation or placement in a system. In certain variations, such materials are used to form an integral component for a compressor. As non-limiting examples, integral components pertain to other mechanical or electromechanical devices, including engines, pumps, and other devices. Exemplary integral components include seals and related components, such as a suction baffle, a suction muffler, a counterweight cup, fittings, fasteners, various fluid passageways, and the like, related to heating, ventilation, and air conditioning (HVAC) systems, refrigeration systems, and other systems. The components of the compressor 10 as detailed above are non-limiting examples of integral components.

As used herein, “scrap” refers to a post-consumer waste material, post-commercial, post-industrial waste material, or a material that would have traditionally been discarded or for which there is no apparent or easy re-use thereof without the addition of unwanted or cumbersome steps. A non-limiting example of the source of the scrap nylon and/or scrap polypropylene according to various aspects of the present teachings is carpet. Carpet generally includes fibers and a backing to secure the fibers. The fibers for a carpet generally include nylon, polypropylene, polyester, and/or wool, as non-limiting examples. In an exemplary carpet, the backing is a mesh or woven material through which the fibers are looped, woven, tied, glued, or otherwise affixed thereto. Adhesives, anti-skid fillers, and other materials are optionally in the carpet backing. Depending on the manufacturer or the treatment, carpets also include stain repellants, anti-static agents, colorants, and the like.

In embodiments where the nylon and/or polypropylene materials are sourced from carpets, exemplary scrap material includes remnants, irregular or defective carpets, or post-consumer or post-industrial carpets. It is understood that while illustrations in the present disclosure identify carpet as the source of both the scrap nylon and the scrap polypropylene, it is understood that the polypropylene and/or the nylon can be a scrap material from a different source other than carpet. It is within the scope of the present teachings that the scrap nylon and scrap polypropylene are sourced from the same or different starting materials.

As used herein, the term “material” refers broadly to a substance or composition containing at least the scrap nylon and scrap polypropylene components, but which may also include various other additives as detailed below. The terms “recycled material” and/or “recycled composition” are used to describe a substance or composition including both the scrap nylon and scrap polypropylene for beneficial reuse and may further include any other optional additives, and broadly refer to matter containing the preferred components, compounds, or composition that forms the integral components.

The relative amounts of materials are sometimes expressed in numerical values, such as percentages. The term “about” when applied to these values or percentages as used in the present teachings indicates that the calculation or the measurement allows some slight imprecision in the value (including near exactness to a value or an approximate or reasonable closeness to the value). If, for some reason, the imprecision provided by “about” is not otherwise understood in the art with this ordinary meaning, then “about” as used herein indicates a possible variation of up to 5% of the indicated value of 5% variance from usual methods of measurement. For example, a component of about 10 weight % could vary between 10±0.5 weight %, thus ranging from between 9.5 and 10.5 weight %. It is understood that all percentages given herein are according to the total weight percentage of the respective composite materials of the present teachings. In addition, disclosure of ranges includes disclosure of all values and further divided ranges within the entire range, including endpoints given for the ranges.

In one aspect of the present teachings, the integral component is formed of a material of scrap nylon and scrap polypropylene. The scrap nylon and/or scrap polypropylene can be provided from a carpet in various embodiments. The scrap nylon and/or scrap polypropylene can also be provided from different sources. The fibers of the carpet generally provide the source of the nylon while the backing of the carpet generally provides the source of the polypropylene. It is understood with certain carpets within the scope of the present teachings, a nylon material may form part of the backing and a polypropylene material may form part of the fibers. Furthermore, other polymers may be present in the scrap materials to be recycled.

It was previously believed that the backing had to be removed from the carpet before the nylon fibers would be suitable for use in a subsequent application. This required cumbersome additional steps to segregate the backing and ultimately slowed processing time while increasing recycling and manufacturing costs. Contrary to these previous beliefs, the present teachings are able to employ both the scrap nylon fibers and scrap polypropylene to provide integral components having improved ductility able to withstand the harsh conditions in a compressor. Additionally, by maximizing the use of more components of the recycled carpet, the present teachings provide an “earth-friendly” benefit.

Any nylon-containing carpet is suitable for the present teachings including indoor and outdoor carpets, rugs, doormats, and the like. The nylon-containing carpets include those having nylon as a primary component of the fibers. In other words, in such aspects, the carpet is made of from about 50% to about 100% of nylon fibers, including all sub-ranges. Nylon-containing carpets also include those with synthetic or natural fibers blended with nylon, for example those including polypropylene or including other non-nylon fibers such as wool, respectively. In other words, in such aspects, the carpet is made of from about 5% to about 50% of nylon fibers, including all sub-ranges. Details on harvesting the materials from the carpet will be provided later herein.

In various aspects, the scrap nylon is nylon 6,6. The nylon is generally present in the recycled composition at from greater than about 30 weight % to less than about 70 weight % of the total weight of the recycled composition, including all sub-ranges. In still other embodiments, the scrap nylon is present in the recycled composition at from greater than about 50 weight % to less than about 65 weight % of the total weight of the recycled composition, including all sub-ranges. In select aspects, the scrap nylon is present in the recycled composition at from greater than about 70 weight % of the total weight of the recycled composition to less than about 100% of the total weight of the recycled composition, including all sub-ranges. In still other aspects, the scrap nylon is present in the recycled composition at from greater than about 70 weight % of the total weight of the recycled composition to less than about 85% of the total weight of the recycled composition, including all sub-ranges.

The scrap nylon is from any suitable source including recycled post-consumer products, post-industrial products, parts from discarded equipment, factory irregular parts made of nylon, carpet, and the like. Additionally, a small amount of virgin (non-scrap) nylon material is optionally added to the recycled composition in certain variations. In such embodiments, the virgin nylon material is present in the recycled composition in an amount less than about 10 weight % of the total weight of the recycled composition, including all sub-ranges.

The scrap polypropylene is generally present in the recycled composition at greater than or equal to about 5 weight % to less than or equal to about 25 weight % by total weight of the recycled composition, including all sub-ranges. In still other embodiments, the scrap polypropylene is present at about 10 weight % to about 18 weight % by total weight of the recycled composition, including all sub-ranges. In still other aspects, the scrap polypropylene is present at about 16.5 weight % by total weight of the recycled composition. The scrap polypropylene may be from any suitable source including recycled post-consumer products, post-industrial products, parts from discarded equipment, factory irregular parts made of polypropylene, carpet, and the like.

The recycled compositions of the present teachings also optionally include an additive to provide heat stabilization to a melt formed from the scrap nylon and scrap polypropylene combination. In various aspects, the heat stabilizer is present at from greater than or equal to about 0 weight % to less than or equal to about 10 weight % of the total recycled composition, including all sub-ranges. Exemplary heat stabilization materials optionally facilitate the scrap nylon and scrap polypropylene combination being thermoplastically processed into an integral component. In various embodiments, the heat stabilization additive is a coating on pellets formed from a mixture of the scrap nylon and scrap polypropylene. In still other embodiments, the heat stabilization additive can be homogenously distributed through a mixture of the scrap nylon and scrap polypropylene.

Suitable heat stabilization materials include copper-based and halide-based materials. As non-limiting examples, suitable heat stabilization materials include copper bromide, copper iodide, calcium bromide, zinc bromide, or magnesium bromide, such as those disclosed in U.S. Pat. No. 4,172,069, issued on Oct. 23, 1979 and assigned to BASF Aktiengsellschaft, which is incorporated by reference in its entirety. Still other suitable stabilizers are disclosed in U.S. Pat. No. 5,447,980, issued on Sep. 5, 1995 and assigned to Amoco Corporation, which is incorporated by reference in its entirety.

Additionally, one of skill in the art appreciates that additional additives can be employed including, but not limited to, colorants (e.g., pigments), other stabilizers, flame retardants, mold release agents, lubricants, etc. In various aspects, a filler such as ash is included. The ash is optionally present at from greater than or equal to about 0 weight % of the total weight of the recycled composition to less than or equal to about 4 weight % of the total weight of the recycled composition, including all sub-ranges. Where a colorant is used, the colorant is present at from greater than or equal to about 0 weight % of the total weight of the recycled composition to less than or equal to about 4 weight % of the total weight of the recycled composition, including all sub-ranges. Exemplary, non-limiting colorants include carbon black and titanium dioxide. It is understood that other colorants well known in the art are also suitable for the present teachings. The filler, colorant, and/or other additional additives are provided separately or along with the scrap nylon and scrap polypropylene during the extrusion of pellets formed therefrom or during the molding of the integral component.

As one example, a recycled composition of the present teachings includes nylon 6,6 at greater than or equal to about 70 by weight of the total recycled composition, polypropylene at from greater than or equal to about 9.3% to less than or equal to about 23.6% by weight of the total recycled composition, a heat stabilizing agent at less than or equal to about 10% by weight of the total recycled composition, ash at about 4% by weight of the total recycled composition, and a colorant at less than or equal to about 4% by weight of the total recycled composition. In another similar example, the scrap nylon and scrap polypropylene can both be sourced from the same post-consumer recycled carpet to form the recycled composition which forms the integral component of the present teachings.

The scrap nylon and scrap polypropylene materials are optionally recycled prior to processing the material to form the integral components of the present teachings. Exemplary preparations include cleaning the source of the scrap material, such as a carpet as a non-limiting example, to remove dirt and debris resulting from the post-consumer or post-industrial use, transportation, and/or storage conditions. Where the scrap materials are sourced from a carpet, additional exemplary pre-treatments include cutting the carpet into smaller sized pieces for ease of processing, or milling the carpet into fragments. An advantage of the present teachings is that the polypropylene backing and related materials can remain intact and need not be removed from the nylon fibers of the carpet prior to recycling. This increases efficiency and maximizes the use of the scrap materials, optimizing the earth-friendly use of the materials. Further, this eliminates additional preparation steps that would require separation of the nylon from the polypropylene backing.

Incorporating the nylon and polypropylene backing together to form the integral components of the present teachings counters traditional nylon recycling. Generally, the recycled or scrap materials are segregated to select the desired component, such as the nylon component of carpets. By including a backing, such as the polypropylene backing, the present teachings have unexpectedly increased the ductility of integral parts formed therefrom. In particular, when used in a compressor application, the combined scrap nylon and scrap polypropylene are able to swell in the presence of the lubricant and refrigerant of the compressor 10. This swelling allows the integral component formed with the recycled composition, including the combined scrap nylon and scrap polypropylene, to dynamically respond to the changing loads of the compressor 10. Further details on the improved performance are illustrated below and in the Examples section.

By way of background, an exemplary process for recycling carpet is disclosed. To obtain the scrap nylon and the scrap polypropylene materials from a carpet, there are several processing steps. First, there is a tolling process in which the carpet is cut into smaller pieces. In an exemplary tolling process, the carpet is cut into strips having a dimension of about 1 inch (approximately 2.5 centimeters) by 4 inches (approximately 10 centimeters). Prior to the tolling or immediately thereafter, debris and dirt are removed from the carpet. The carpet can be agitated to loosen debris and/or the carpet is washed to remove other debris or stains. The tolled and cleaned pieces are then chopped into finer pieces or particles. Suitable methods for preparing the carpets are disclosed in U.S. Pat. No. 6,752,336 issued on Jun. 22, 2004 and U.S. Pat. No. 7,784,719 issued on Aug. 31, 2010, both assigned to Wellman Plastics Recycling, LLC and incorporated herein in their entirety.

In various aspects, the finer particles of the carpet are mixed with a carrier fluid, such as water or another suitable fluid, to provide a slurry to facilitate separation of the scrap nylon and scrap polypropylene from the other components of the carpet. In various aspects of the present teachings, at least the scrap nylon and scrap polypropylene components are used to form the integral components. In still other aspects, residual adhesives and other materials in the carpet remain with the scrap nylon and scrap polypropylene components are subsequently incorporated into the integral components. The amount of residual adhesives and other materials that are left after separation in addition to the scrap nylon and scrap polypropylene is from greater than about 0.01 weight % to less than about 10 weight % by total weight of the recycled composition, including all sub-ranges.

After the scrap materials are prepared accordingly or are obtained, they are formed via conventional processing techniques into useable pellets for injection molding into the final shape of the integral component. The heat stabilizing additives such as those detailed above allow the scrap nylon and scrap polypropylene to be melted together at a sufficiently high temperature to provide an integral component having adequate physical and chemical integrity to withstand formation and integration into the operating compressor environment. In various aspects, the integral component is formed by conventional processing techniques such as injection molding, compression molding, extrusion, and the like, as non-limiting examples. In one example, the pellets are extruded on a twin screw extruder and any desired additives may be incorporated prior to injection molding into the final integral component.

In embodiments where a molding technique is employed, the melted recycled composition including the scrap nylon and scrap polypropylene may be introduced into a mold having one or more mold cores. During the molding or during the extrusion, additives such as those detailed above are optionally added to the mixture of the melted nylon and polypropylene. In still other aspects, the melted materials may be formed into pellets which are then subsequently heated and extruded to form the integral component or disposed into a mold to form the integral component.

The recycled composition including the melted scrap nylon and scrap polypropylene assumes the shape of an interior portion of the mold and any cores after the part is solidified. A mold release agent is optionally used in aspects of the present teachings to help remove the integral component from the mold. The part is then removed from the mold and prepared for use as an integral component, such as those detailed above. For example, the integral component can be further processed (e.g., machined, cured, sealed, and/or painted). It is understood that several molded parts may be combined to form the integral component or that only a portion of the integral component can be formed from the melted scrap nylon and scrap polypropylene.

In certain aspects, the methods of the present teachings are capable of providing integral components having improved ductility within the compressor 10, the benefits of which can last up to ten years or longer. Ductility is generally understood to be a measure of a material's ability to undergo appreciable plastic deformation before fracture, generally expressed as a percentage of elongation or percentage of area reduction. For example, the benefits of improved ductility can last a duration of greater than or equal to about six months, optionally greater than or equal to one year, optionally greater than or equal to two years, optionally greater than or equal to three years, optionally greater than or equal to five years, optionally greater than or equal to eight years, and in certain aspects, optionally greater than or equal to ten years, including all sub-ranges. Similarly, improved ductility can be quantified in periods of thousands of working hours, as is sometimes used to describe the life of certain devices like compressors. Thus, long-term ductility improvement of the present technology can provide an integral component that lasts for greater than or equal to about 1,000 working hours, optionally greater than or equal to about 2,000 working hours, optionally greater than or equal to about 3,000 working hours, optionally greater than or equal to about 5,000 working hours, optionally greater than or equal to about 7,000 working hours, optionally greater than or equal to about 10,000 working hours.

In various embodiments, the integral component is placed at a location inside the scroll compressor 10 for example on an internal wall of the scroll compressor 10. Preferably, the integral component is located in the scroll compressor 10 at a location that facilitates contact with the refrigerant and/or lubricant. The improved ductility can be achieved after the scroll compressor 10 is created, after the hermetic sealing, after incorporation of the scroll compressor 10 into a larger system, after testing or part validation, after a repair, or at any other point of the life of the scroll compressor 10. Contacting the refrigerant and/or lubricant with the integral component can occur concurrently with the charging of the scroll compressor 10. Charging the scroll compressor 10 is ongoing during operation of the hermetically sealed device including in active fluid displacement operational mode, a stand-by operational mode, and/or in an off or non-operational condition. Further, the charging can occur after the scroll compressor 10 is created, after the hermetic sealing, after incorporation of the scroll compressor 10 into a larger system, after testing or part validation, after a repair, or at any other point of the life of the scroll compressor 10. The ductility improves during the on-, off-, and standby-modes for the compressor 10.

Any combination of refrigerant(s) and lubricant(s) is suitable in certain variations of the present teachings. The selection of the refrigerant and lubricant in various embodiments is made based on the type of refrigeration system into which the integral component is incorporated. In certain variations, suitable refrigerants may include refrigerants selected from the group consisting of: hydrofluorocarbons, hydrochlorofluorocarbons, perfluorocarbons, hydrofluorocarbon ethers, perfluorocarbon ethers, hydrocarbons, carbon dioxide, ammonia, dimethyl ethers, fluoroolefins, and combinations thereof. In certain aspects, the refrigerant is a hydrofluorocarbon (HFC) or a hydrochlorofluorocarbon (HCFC). Particularly suitable refrigerants for use in conjunction with the present teachings include chlorodifluoromethane (HCFC-22 or R-22); HFC-407C or R-407C that is a ternary blend of hydrofluorocarbons: namely difluoromethane (HFC-32 or R-32), pentafluoroethane (HFC-125 or R-125), and 1,1,1,2-tetrafluoroethane (HFC-134a or R-134A); HFC-410A or R-410A, which is a near-azeotropic mixture of difluoromethane (HFC-32 or R-32) and pentafluoroethane (HFC-125 or R-125); or HFC-404A or R-404A that is a nearly azeotropic mixture of 1,1,1-trifluoroethane (HFC-143A or R-143A), pentafluoroethane (HFC-125 or R-125) and 1,1,1,2-tetrafluoroethane (HFC-134A or R-134A). In certain aspects, the refrigerant can be selected from the group consisting of: HCFC-22/R-22; HFC-407C/R-407C; HFC-410A/R-410A; HFC-404A/R-404A; and combinations thereof.

The compositions of the present invention may further comprise a refrigeration lubricant or those lubricants suitable for use with refrigeration, air-conditioning, or heat pump apparatuses. Lubricants may include those known as “mineral oils,” which generally comprise paraffins (e.g., straight-chain and branched-carbon-chain saturated hydrocarbons), naphthenes (e.g., cyclic paraffins) and aromatics (e.g., unsaturated cyclic hydrocarbons containing one or more rings characterized by alternating double bonds). Other lubricants may be selected from those commonly known as “synthetic oils” for refrigeration lubrication. Such synthetic oils comprise polyol esters, polyvinyl ethers, polyalkylene glycols, poly(alpha)olefins, alkylaryls (e.g., linear and branched alkyl alkylbenzenes), synthetic paraffins and napthenes, and poly(alphaolefins), by way of non-limiting example. Therefore, in various aspects, a lubricant can be selected from the group consisting of mineral oil, polyol esters, polyvinyl ethers, polyalkylene glycols, alkylbenzenes, synthetic paraffins, synthetic napthenes, poly(alpha)olefins, and combinations thereof. In particularly suitable variations, a lubricant is selected from the group consisting of mineral oil, polyol esters, polyvinyl ethers, and combinations thereof.

In one exemplary embodiment, a combination of the lubricant blended white mineral oil (BWMO) and the refrigerant chlorodifluoromethane (R-22) is used to improve the ductility of the integral component. In another exemplary embodiment, a combination of the lubricant synthetic polyvinyl ether oil and a refrigerant (R-407C) is used to improve the ductility of the integral component. In yet another exemplary embodiment, a combination of the lubricant synthetic polyvinyl ether oil and a refrigerant (R-410A) is used to improve the ductility of the integral component. In other embodiments, a combination of the lubricant synthetic polyol ester oil and a refrigerant (R-407C) is used to improve the ductility of the integral component. In certain further embodiments, a combination of the lubricant synthetic polyol ester oil and a refrigerant (R-410A) is used to improve the ductility of the integral component. In yet other embodiments, a combination of the lubricant synthetic polyol ester oil and a refrigerant (R-404A) is used to improve the ductility of the integral component. When the refrigerant and/or lubricant contact the integral component, there is a swelling of the combined scrap nylon and scrap polypropylene that allows the integral component to become more responsive to the conditions of the working compressor.

As detailed in the Examples section, the strain at break percentage is increased in systems incorporating the blended white mineral oil and R-22 or alternatively the polyol ester oil or the polyvinyl ether oil with R-407C, R-410A, or R404A. In various aspects, the scrap nylon incorporated into the present teachings has a strain at break percentage that is increased by up to about 80% as compared to an integral component that solely includes a virgin nylon material. As detailed in the Examples section, the tensile modulus or the measure of stiffness of an elastic material by determining a ratio percentage of stress to elastic strain is desirably decreased for recycled composition compared to a virgin nylon material. In various aspects, contacting the integral component with at least one of the refrigerant and the lubricant reduces the tensile modulus of the material to less than about 150 thousand pound-force per square inch at 125 degrees C.

Further, as will be detailed in the Examples section, the tensile strength, or the maximum stress that a material can withstand while being stretched without the cross-section starting to significantly contract, is significantly increased for integral components incorporating the recycled composition. As an example, the tensile strength is nearly three-fold greater for the scrap nylon than it is for the virgin nylon materials. For example, contacting the integral component with at least one of the refrigerant and the lubricant reduces the tensile strength of the integral component to less than about 6 thousand pound-force per square inch at 125 degrees C.

The integral components formed using the scrap nylon and scrap polypropylene of the present teachings are believed to similarly have an increased tensile strength, decreased tensile modulus, and increased strain at break which collectively provide the enhanced ductility of the integral component. This enhanced ductility allows the integral component to respond to the changing loads and demands of the working compressor.

Turning to FIG. 2, a counterweight cup 90 as detailed above is formed of a recycled composition including the scrap nylon and polypropylene. The counterweight cup 90 is an exemplary integral component or working component for the compressor 10. In such an embodiment, the combined scrap nylon and scrap polypropylene are formed into the shape of the counterweight cup by molding. In such embodiments, the counterweight cup 90 is secured to an interior of the scroll compressor 10 by traditional securing methods, such as using e-clips, welds, and the like.

It is understood that it is within the scope of the present teachings to use a single integral component made of the mixture of the scrap nylon and polypropylene material or to incorporate several different or similar integral components made of the combined scrap nylon and polypropylene material. By contacting the lubricant and/or refrigerant with the element made of the scrap nylon and polypropylene material, the present teachings provide enhanced ductility and responsive performance of the compressor 10. This helps to decrease the frequency and expense of replacing the scroll compressor 10 and/or the system into which the scroll compressor 10 is incorporated. Further, this decreases costs and environmental impact by utilizing a scrap material.

In summary, in various aspects the present teachings provide methods of forming an integral component for a compressor. A recycled composition including a scrap nylon and a scrap polypropylene is shaped to form a solid integral component for the compressor. The recycled composition is optionally provided by melting a post-consumer waste carpet. In various aspects, the post-consumer waste carpet is cleaned and shredded prior to the melting. The melting is conducted while at least a portion of a backing of the carpet comprising the polypropylene remains affixed to at least a portion of a plurality of fibers of the carpet including the nylon in various aspects. The scrap nylon includes from greater than or equal to about 30 weight % to less than or equal to about 70 weight % of the total weight of the recycled composition. In certain variations, the scrap nylon is from at least two different sources. The scrap nylon is a post-consumer waste, post-commercial, or a post-industrial waste in various aspects. In still other features, the polypropylene provides from greater than or equal to about 5 weight % to less than or equal to about 25 weight % of the total weight of the recycled composition. Optionally, the recycled composition further includes a virgin nylon material at less than or equal to about 10 weight % of the total weight of the recycled composition. The recycled composition includes a heat stabilizer in other select aspects. The integral component formed includes a counterweight cup, a wire guard, a suction baffle, and a suction muffler in various aspects.

In still other features of the present teachings, methods of improving ductility of an integral component of a compressor are provided. The integral component of the compressor is formed with a recycled composition obtained from scrap carpet including nylon fibers and a polypropylene backing. The integral component is contacted and infiltrated with at least one of a refrigerant and a lubricant. In various aspects, the integral component is infiltrated with a combination of the refrigerant and the lubricant. In certain variations, the lubricant includes a blended white mineral oil and the refrigerant includes chlorodifluoromethane (R-22) in various aspects. In still other features, the nylon fibers and polypropylene backing are melted together to form an extrudable material. The contacting and infiltrating improves a ductility of the integral component by at least 10% as compared to a ductility of an integral component formed from only a nylon material in various aspects. Optionally, contacting the integral component with at least one of the refrigerant and the lubricant causes swelling of the integral component. In still other features, contacting the integral component with at least one of the refrigerant and the lubricant increases the strain at break of the integral component. In other aspects, contacting the integral component with at least one of the refrigerant and the lubricant reduces the tensile modulus of the integral component. Still further, contacting the integral component with at least one of the refrigerant and the lubricant reduces the tensile modulus of the material to less than about 150 thousand pound-force per square inch at 125 degrees C. in various aspects. In other aspects, contacting the integral component with at least one of the refrigerant and the lubricant provides a strain break percentage of greater than or equal to about 70% at 125 degrees C. In still other aspects, contacting the integral component with at least one of the refrigerant and the lubricant reduces the tensile strength of the integral component to less than about 6 thousand pound-force per square inch at 125 degrees C. The integral component formed includes a counterweight cup, a wire guard, a suction baffle, and a suction muffler in various aspects.

The present teachings in other aspects provide methods of forming a compressor. An integral component is disposed on an internal surface of the compressor, where the integral component is formed of a recycled composite material scrap nylon and scrap polypropylene. A housing is hermetically sealed forming part of the compressor about the integral component. In various aspects, the compressor is charged with at least one of a refrigerant and a lubricant. In certain aspects, the lubricant is optionally selected from a group consisting of: mineral oil, polyvinyl ether oil, polyol ester oil, and combinations thereof, while the refrigerant is selected from a group consisting of: R-22 (chlorodifluoromethane), R-407C (a mixture of difluoromethane, pentafluoroethane, and 1,1,1,2-tetrafluoroethane), R-410A (a mixture of difluoromethane and pentafluoroethane), R-404A (a mixture 1,1,1-trifluoroethane, pentafluoroethane, and 1,1,1,2-tetrafluoroethane), and combinations thereof. In still other aspects, the integral component is contacted with a combination of the refrigerant chlorodifluoromethane (R-22) and the lubricant comprising blended white mineral oil. The ductility of the integral component is increased in the presence of the chlorodifluoromethane and blended white mineral oil during an operating condition of the compressor in select aspects.

Still further, the integral component is secured at a location inside the compressor adjacent a fluid collection area or adjacent a flow path for at least one of the refrigerant and the lubricant. Contacting the refrigerant with the integral component occurs concurrently with the charging of the system with at least one of the refrigerant and the lubricant in various aspects. The recycled composite material is capable of having improved ductility during an operating condition of the scroll compressor selected from on-, off-, or standby-conditions in various aspects. The integral component formed includes a counterweight cup, a wire guard, a suction baffle, and a suction muffler in various aspects.

In still other aspects, the present teachings provide an integral component for a scroll compressor formed from a recycled composition including a scrap nylon and a scrap polypropylene.

### EXAMPLES

A Control of nylon 6,6 and a Recycled Sample of nylon 6,6 according to the present teachings were tested to determine the impact of exposure of the respective nylon materials to various combinations of lubricants and/or refrigerants. The respective nylon materials were tested for tensile strength, strain at break, and tensile modulus after 14 day exposure at 125 degrees C. As a control for each of the Control and the Recycled Sample, the respective nylon materials were tested in their native state (no exposure to heat, lubricant, or refrigerant) and with heat alone. The various combinations of lubricants and/or refrigerants were: blended white mineral oil (BWMO); blended white mineral oil and chlorodifluoromethane (R-22); synthetic polyvinyl ether oil (FVC68D); FVC68D combined with a ternary blend of hydrofluorocarbons difluoromethane, pentafluoroethane, and 1,1,1,2-tetrafluoroethane (R-407C); FVC68D combined with difluoromethane and pentafluoroethane (R-410A); a synthetic polyol ester oil (3MAF); 3MAF combined with difluoromethane and pentafluoroethane (R-410A); 3MAF combined with pentafluoroethane, ethane, 1,1,1-trifluoroethane (HFC-143a), 1,1,1,2-tetrafluoroethane (HFC-134a) (R404A); and 3MAF and a ternary blend of hydrofluorocarbons difluoromethane, pentafluoroethane, and 1,1,1,2-tetrafluoroethane (R-407C). The respective treatments for each of the Control and the Recycled Sample prepared in accordance with certain variations of the present teachings are referred to as “iterations.”

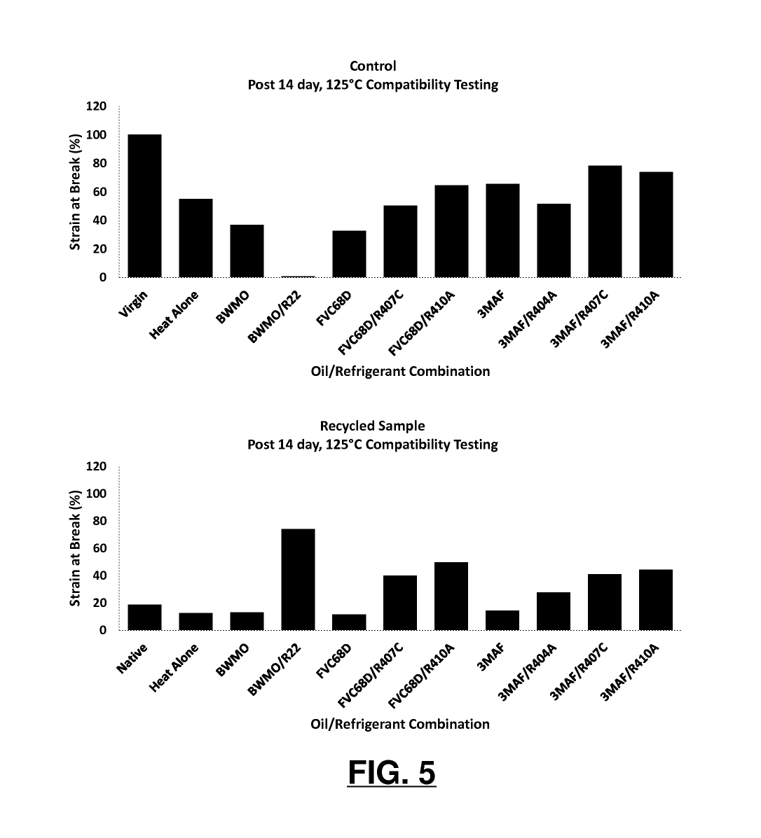

Generally, as illustrated in FIGS. 5-7, the Recycled Sample performed better than the Control. With respect to FIG. 5, the trend is that the strain at break percentages which were relatively higher or lower, respectively for the Control, was lower or higher, respectively for the Recycled Sample. For example, the native state (no exposure to heat, lubricant, or refrigerant) Control had a strain at break of 100%. To the contrary, the native state (no exposure to heat, lubricant, or refrigerant) Recycled Sample had a superior strain at break of nearly 20%. Further, the blended white mineral oil and R-22 mixture for the Control had a strain at break of approximately 0%. Again, to the contrary, the blended white mineral oil and R-22 mixture for the Recycled Sample had a superior strain at break percentage of over 75%. Similarly, the synthetic polyol ester oil and polyvinyl ether oil likewise had favorable strain at break percentages as compared to those of the Control (for test conditions lacking any refrigerant or those with R404A or R-407C or R-410A). Integral components formed from recycled composition including the scrap nylon and scrap polypropylene of the present teachings provide improved ductility via the reduced strain at break percentage of the Recycled Sample.

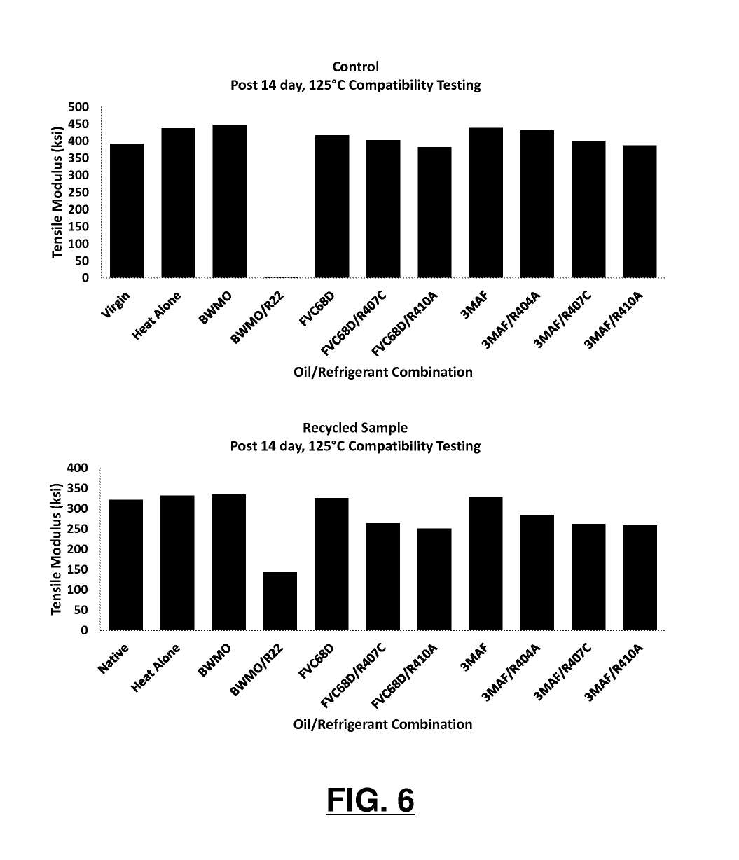

Referring to FIG. 6, the trend is that the tensile modulus or the measure of stiffness of an elastic material is decreased for most of the Recycled Sample iterations as compared to the Control Example iterations. For example, the native state (no exposure to heat, lubricant, or refrigerant) of the Control had a tensile modulus of approximately 390 thousand pound-force per square inch (ksi) while the native state (no exposure to heat, lubricant, or refrigerant) of the Recycled Sample had a tensile modulus of approximately 320 thousand pound-force per square inch (ksi). While the blended white mineral oil by itself had a lower tensile modulus of about 325 thousand pound-force per square inch (ksi) for the Recycled Sample as compared to the Control having 440 thousand pound-force per square inch (ksi).

However, the Control in the presence of the combination of blended white mineral oil and R-22 had a tensile modulus of approximately one thousand pound-force per square inch (ksi), while the Recycled Sample had a tensile modulus of approximately 142 thousand pound-force per square inch (ksi) in the presence of the blended white mineral oil and R-22. The Control had a brittleness that was such that with any measurable force applied to the Control, a brittle fracture occurred. Considering the modulus is obtained from the linear portion of a stress/strain curve, and the obvious lack of such a curve segment, no measurable metric for modulus was attainable.

In FIG. 6, the synthetic polyol ester oil and polyvinyl ether oil likewise had lower strain at break percentages as compared to those of the Control (for test conditions lacking any refrigerant or those with R404A or R-407C or R-410A). Generally, the respective iterations of the Control and the Recycled Sample showed that the Recycled Sample iterations had decreased the tensile modulus by approximately 75 to 100 thousand pound-force per square inch (ksi). The results for the Recycled Sample indicate that there was an increase in tensile modulus for the Recycled Sample in the presence of the specific combination of lubricant and refrigerant.

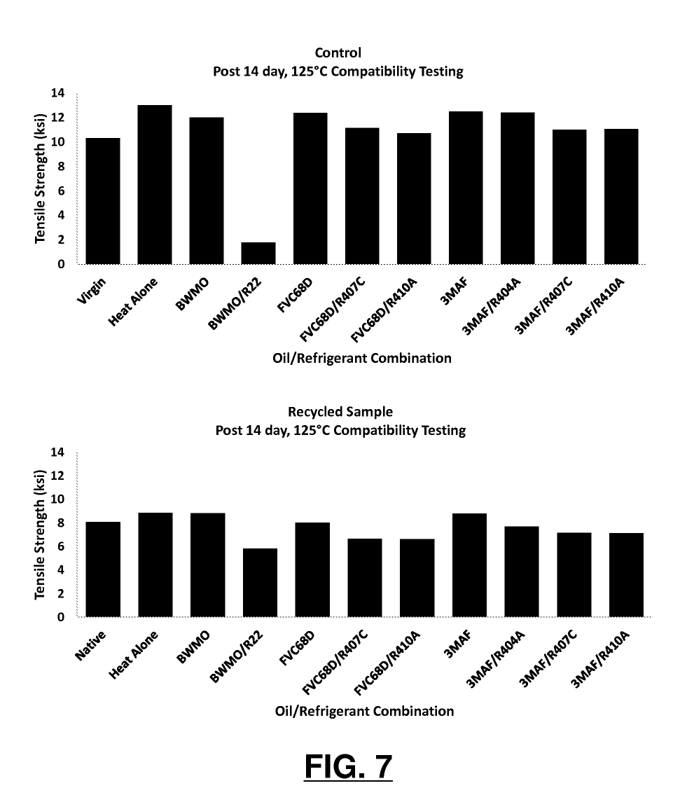

FIG. 7 shows trends of the tensile strength or the maximum stress that a material can withstand before the cross-section of the sample begins to significantly contract. The results of the iterations of testing the Control and the Recycled Sample indicate that the tensile strength is significantly lowered in the Recycled Sample for the majority of iterations. For example, the native state (no exposure to heat, lubricant, or refrigerant) had a tensile strength of approximately 10 thousand pounds-force per square inch (ksi) for the Control while the native state (no exposure to heat, lubricant, or refrigerant) had a tensile strength of approximately 8 thousand pounds-force per square inch (ksi) for the Recycled Sample. Accordingly, the maximum amount of stress that the Recycled Sample could withstand was less than that of the Control for the majority of iterations, with that being related to the recycling process and the history of exposure of the polymer.

The synthetic polyol ester oil and polyvinyl ether oil likewise had lower tensile strength as compared to those of the Control (for test conditions lacking any refrigerant or those with R404A or R-407C or R-410A). With respect to the combination of blended white mineral oil and R-22 in the presence of such a heat transfer fluid, the maximum amount of stress that the Recycled Sample could withstand was significantly higher as compared to the Control. The tensile strength for the Control was less than about 2 ksi while the tensile strength for the Recycled Sample was nearly 6 ksi. This three-fold increase in tensile strength indicates that the Recycled Sample has a greater ability to respond to the conditions of the compressor due to the ability withstand an increased amount of maximum stress as compared to the Control.

In certain variations, it is believed that the marked increase in the tensile strength, strain at break percentage, and tensile strength for the recycled composition in the presence of the combination of blended white mineral oil and R-22 indicates a synergy between that combination of refrigerant and lubricant and the recycled materials. Likewise, the increase in the tensile strength, strain at break percentage, and tensile strength for the recycled composition in the presence of the combination of polyvinyl ether oil lubricant and R-407C or R-410A refrigerants or alternatively polyol ester oil lubricant and R-407C, R-410A, or R-404A refrigerants provided unexpected benefits due to the combination of refrigerant and lubricant and the recycled materials. The superior increased ductility allows integral components made from the recycled compositions of the present teachings to be highly responsive to the demands of the compressor environment.

Those skilled in the art can now appreciate from the foregoing discussion that the broad teachings of the present disclosure can be implemented in a variety of forms. It should be appreciated that the foregoing description of the present teachings is merely exemplary in nature and, thus, variations that do not depart from the gist of the teachings are intended to be within the scope of the teachings. Such variations are not to be regarded as a departure from the spirit and scope of the teachings.

What is claimed:

1. A method of forming an integral component for a compressor comprising:
shaping a recycled composition comprising a scrap nylon and a scrap polypropylene to form a solid integral component for the compressor.

2. The method of claim 1, further comprising melting a post-consumer waste carpet to provide the recycled composition comprising the scrap nylon and the scrap polypropylene.

3. The method of claim 2, further comprising cleaning and shredding the post-consumer waste carpet prior to the melting.

4. The method of claim 3, wherein the melting of the post-consumer waste carpet is conducted while at least a portion of a backing of the carpet comprising the polypropylene remains affixed to at least a portion of a plurality of fibers of the carpet comprising the nylon.

5. The method of claim 1, wherein the scrap nylon comprises from greater than or equal to about 30 weight % to less than or equal to about 70 weight % of the total weight of the recycled composition.

6. The method of claim 1, wherein the scrap nylon is from at least two different sources.

7. The method of claim 1, wherein the scrap nylon is post-consumer waste carpet or post-industrial waste carpet.

8. The method of claim 1, wherein the polypropylene comprises from greater than or equal to about 5 weight % to less than or equal to about 25 weight % of the total weight of the recycled composition.

9. The method of claim 1, wherein the recycled composition further comprises a virgin nylon material at less than or equal to about 10 weight % of the total weight of the recycled composition.

10. The method of claim 1, wherein the recycled composition further comprises a heat stabilizer.

11. The method of claim 1, wherein the integral component is selected from a counterweight cup, a wire guard, a suction baffle, and a suction muffler.

12. A method of improving ductility of an integral component of a compressor comprising:
a. forming the integral component of the compressor with a recycled composition obtained from scrap carpet comprising nylon fibers and a polypropylene backing; and
b. contacting the integral component with at least one of a refrigerant and a lubricant.

13. The method of claim 12, further comprising infiltrating the integral component with a combination of the refrigerant and the lubricant.

14. The method of claim 13, wherein the lubricant is selected from a group consisting of: mineral oil, polyvinyl ether oil, polyol ester oil, and combinations thereof; and the refrigerant is selected from a group consisting of: R-22 (chlorodifluoromethane), R-407C (a mixture of difluoromethane, pentafluoroethane, and 1,1,1,2-tetrafluoroethane), R-410A (a mixture of difluoromethane and pentafluoroethane), R-404A (a mixture 1,1,1-trifluoroethane, pentafluoroethane, and 1,1,1,2-tetrafluoroethane), and combinations thereof.

15. The method of claim 14, wherein the lubricant comprises a blended white mineral oil and the refrigerant comprises R-22 (chlorodifluoromethane).

16. The method of claim 12, wherein the nylon fibers and polypropylene backing are melted together to form an extrudable material.

17. The method of claim 12, wherein the contacting and infiltrating improves a ductility of the integral component by at least 10% as compared to a ductility of an integral component formed from only a nylon material.

18. The method of claim 12, further comprising contacting the integral component with at least one of the refrigerant and the lubricant to cause swelling of the integral component.

19. The method of claim 12, wherein contacting the integral component with at least one of the refrigerant and the lubricant increases a strain at break of the integral component.

20. The method of claim 12, wherein contacting the integral component with at least one of the refrigerant and the lubricant reduces a tensile modulus of the integral component.

21. The method of claim 12, wherein contacting the integral component with at least one of the refrigerant and the lubricant reduces a tensile modulus of the integral component to less than about 150 thousand pound-force per square inch at 125 degrees C.

22. The method of claim 12, wherein contacting the integral component with at least one of the refrigerant and the lubricant provides a strain break percentage of greater than or equal to about 70% at 125 degrees C.

23. The method of claim 12, wherein contacting the integral component with at least one of the refrigerant and the lubricant reduces a tensile strength of the integral component to less than about 6 thousand pound-force per square inch at 125 degrees C.

24. The method of claim 12, wherein the integral component is selected from a counterweight cup, a wire guard, a suction baffle, and a suction muffler.
